(19) United States
(12) Patent Application Publication
(10) Pub. No.: US 2006/0161455 A1
(43) Pub. Date: Jul. 20, 2006

(54) Method for management of fitness, health and/or wellness specialist services

(76) Inventor: Taryn Anastasia, San Juan Bautista, CA (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 11/286,145

(22) Filed: Nov. 23, 2005

Related U.S. Application Data
(60) Provisional application No. 60/630,773, filed on Nov. 24, 2004.

(51) Int. Cl. G06Q 10/00

(52) U.S. Cl. 705/2

(57) ABSTRACT

One aspect of the present invention provides for a process and method of management of fitness, health and/or wellness specialist services based on the time needs and/or wants of an individual. This aspect comprises the steps of creating an account balance of specialist minutes by purchasing a block of specialist minutes on a per unit cost; using the specialist services for a period of minutes based on the needs of the individual; then reducing the account balance by the period of minutes previously used. This allows for more control by the individual over the amount of time spent on specialist services. Further the present inventive method allows for the tracking of the specialist minutes by an individual. This aspect allows for the tracking of an individual's specialist time usage. This allows for the improved monitoring individual health programs, along with the monitoring of a specialist's time, which can lead to greater effective health programs for the individual and more efficient usage of a specialist's time.

### REFERENCE TO PENDING APPLICATIONS

This application claims benefit of U.S. Provisional Patent Application Ser. No. 60/630,773 filed on Nov. 24, 2004 entitled METHOD FOR MANAGEMENT OF HEALTH AND/OR WELLNESS COACH SERVICES.

### REFERENCE TO MICROFICHE APPENDIX

This application is not referenced in any microfiche appendix.

### BACKGROUND OF THE INVENTION

1. Field of the Invention

The present invention generally relates to a process and method for the management of fitness, health and/or wellness specialist services. More particularly, the present invention relates to a method for the management of fitness, health and/or wellness specialist services to conform to a user's needs by utilizing a pay by the minute procedure and the tracking of a user's time.

2. Background

Although the general benefits of a healthy lifestyle are common knowledge today, in recent years the approach to getting fit, losing weight, increasing cardiovascular endurance, or recovering from specific health problems has become much more specialized. With specialized knowledge in areas such as exercise science, nutrition, health screening, massage therapy, and fitness assessment, fitness, health and wellness specialists are being used to help people maximize the effects of exercise and a healthy lifestyle. An issue with the use of obtaining a healthy lifestyle is the desire to be in good health in as quick of time as possible. As used herein, the term fitness, health and/or wellness specialist means personal trainers, exercise specialists, nutritionists, massage therapists, and any other individual trained, irrespective of certification or registration, who assists individuals obtaining and/or maintaining a healthy lifestyle.

Many individuals turn to fitness, health and/or wellness specialists for their expertise in instruction, motivation, and guidance, whether at a health club, corporate fitness center, hospital, physical therapy clinic, occupational health clinic or other related type of setting, and whether during a one-on-one private session or in a group setting. Because fitness, health and/or wellness specialists can develop individualized health programs based on a person's unique needs and goals, the results are maximized

The extent of the reliance upon a fitness, health and/or wellness specialist will depend upon a number of factors, including person's own level of experience, health, motivation and time management. For example, a novice would, in most cases, require more attention from a specialist than that same person who has been actively participating in a health program for six months. Everyone's health needs and/or wants are different and those needs/wants change over time. Thus, one person may require a very strict health program with extensive involvement from a fitness, health and/or wellness specialist whereas another may only need minimal attention from a specialist. Further, a person may only want to be involved with a specialist for a short amount to time, whereas another individual may want to spend many hours with a specialist.

In the situation when a person is starting a health program, the person's health is typically assessed in order to determine that person's individual's detailed health and lifestyle information and to develop a starting fitness level. A specific health program is then created to achieve the desired goal of the individual. Such goals can include, but are not limited to, the reduction of body fat, lose or maintain weight, shape and tone muscles, and improve overall fitness. The program can include various features, including the modification of the person's nutrition, establishing a regular exercise routine and the like. Fitness, health and/or wellness specialists can be involved in many aspects of this program. Some examples include: monitoring the individual's progress, fine-tuning it as needed; training the individual on various health and fitness equipment; leading the individual in exercise routines and educating the individual as to how to lead a more healthy lifestyle. Additionally, a specialist could be involved with the taking of measurements, such as an individual's weight, percentage of body fat and other body measurements, cardiovascular improvements, and levels of muscle strength and endurance.

Typically, a person is more reliant on a specialist's services during the initial creation of a health program than during the later stages of the program. However, an individual would be still required to pay for an entire pre-established appointment with the specialist, even when the individual's needs do not require such attention. In this situation, because the individual must pay a fee for the entire appointment, undue tension can be created between the individual and fitness, health and/or wellness specialist, which leads to discouragement, lack of motivation, and a financial tension. This tension can lead individuals to stop using the specialist, which leads to a break down in the health program.

As an example, consider a individual whose health program includes twice-weekly, sixty-minute physical fitness workouts, each of which include a sixty-minute appointment with a personal trainer. However, over time, the individual may feel it would be better to change to four per week, twenty-minute workouts with involvement with the physical trainer being varied based on the type of workout and amount of time the individual wants to commit. In order to utilize the physical trainer, the individual would still be required to schedule an appointment having a pre-determined length of time, i.e. thirty minutes, sixty minutes, etc., and pay for that appointment, irrespective of the individual's needs. By having to pay for time which is not needed, or wanted, the individual may become disenfranchised with the health program and stop participation therein.

Another disadvantage with the typical management of a health program includes the inability to track the individual's frequency of participation within the respective facility, length of visit at the facility, the actual usage of a specialist's services or the time a particular specialist was utilized. The use of preset amounts of time does not take into consideration the situations where an individual does not want to, or need to, utilize the entire amount of time of a specialist's appointment. This leads to inaccurate time records for the individual and the health and/or wellness specialist. This inaccuracy can have various ramifications. In the situation where a health club employs multiple health and/or wellness specialists, the inaccuracy in the amount of actual time a particular health and/or wellness specialist has been utilized can affect the health clubs determination of effectiveness and profitability.

Accordingly, there is a need to create a method of the management of fitness, health and/or wellness specialist services that addresses the needs set out above.

### SUMMARY OF THE INVENTION

The present invention satisfies the needs discussed above. The present invention generally relates to a process and method for the management of fitness, health and/or wellness specialist services. More particularly, the present invention relates to a method for the management of fitness, health and/or wellness specialist services to conform to a user's needs by utilizing a pay by the minute procedure and the tracking of a user's time.

One aspect of the present invention provides for a method of management of fitness, health and/or wellness specialist services based on the time needs, or wants, of an individual. This aspect comprises the steps of creating an account balance of specialist minutes by purchasing a block of specialist minutes; using the specialist services for a period of minutes based on the needs and/or wants of the individual; then reducing the account balance by the period of minutes previously used.

This aspect allows an individual to have access to a fitness, health and/or wellness specialist's expertise for a specific amount of time based on the individual's particular needs and/or wants. The individual is not required to pay for unnecessary specialist time. This reduces any tension the individual may feel toward the specialist due to the individual being in control over the amount of actual time being spent with the specialist.

Additionally, this aspect allows a specialist to maximize her effectiveness with multiple clients. By being able to spend only the time needed per client, she is able to address more client needs in the same amount of time than under the prior art systems.

Moreover, this aspect allows for the tracking of an individual's time spent with a specialist. This allows for the improved monitoring individual health programs, along with the monitoring of a specialist's time. This information can lead to greater effective health programs for the individual and more efficient usage of a specialist's time.

Another aspect of the present invention includes the various ability to purchase time. One variation is the point of sale purchase, i.e. purchase 15 minutes to participate in a specialist lead group exercise. Another variation is the period purchase, including short term and long term purchases. During both the short term and long term purchase an individual agrees to buy, over a series of time periods, a specific amount of time per period, where the short term agreement is for a few time periods and the long term agreement is for many time periods. Moreover, this time is to be used during the month in which they were purchased. As an example, the purchase of 60 minutes of time per month for three months could be considered a short term agreement whereas an agreement that extends for 12 mouths could be considered a long term agreement. This example is illustrative and is not meant to be a limit on the scope of the present invention. Another variation is the paid in full arrangement. This arrangement allows an individual to purchase a block of time, such as 1000 specialist minutes, which can be used at any time by the individual.

Additional variations of this aspect include adjusting the per unit cost of fitness health and/or wellness specialist minutes based on the volume of minutes purchased such that the more minutes purchased, the lower the cost is per unit. An example of this includes purchasing 100 specialist minutes at $2.00 per minute as compared to purchasing 500 specialist minutes at $1.00 per minute.

Moreover, the present inventive method can incorporate client billing features. These features can include the automatic refreshing of an individual's account in the event the account balance of minutes drops below a minimum level of minutes.

Another aspect of the present invention provides for a process of payment of fitness, health and/or wellness specialist services on a per minute basis where the management of the method is controlled by a computer system having various hardware and software components. The computer system can be local to the health and/or wellness specialist or can be a computer network having various computer hardware components such as at least one data server and one or more client computers; along with a compatible computer software component.

Further features of the present invention will be apparent to those skilled in the art upon reference to the accompanying drawings and upon reading the following description of the preferred embodiment.

### BRIEF DESCRIPTION OF THE DRAWINGS

FIG. 1 is a schematic, block diagram of an exemplary service coordination system of the invention;

FIG. 2 is a block diagram of a computer system which may be used in the practice of the invention;

FIG. 3 is a flow diagram of an exemplary of health and/or wellness management method of the invention:

FIG. 4 is a flow diagram of a second exemplary method of health and/or wellness management of the invention; and

FIG. 5 is a flow diagram of a third exemplary method of health and/or wellness management of the invention.

### DETAILED DESCRIPTION OF THE PREFERRED EMBODIMENTS

Before explaining the present invention in detail, it is to be understood that the invention is not limited to the preferred embodiments contained herein. The invention is capable of other embodiments and of being practiced or carried out in a variety of ways. It is to be understood that the phraseology and terminology employed herein are for the purpose of description and not of limitation.

As used herein, the term “fitness, health and/or wellness specialist” means personal trainers, exercise specialists, nutritionists, massage therapists, and any other individual trained, irrespective of certification or registration, who assists individuals obtaining and/or maintaining a healthy lifestyle.

The present invention satisfies the needs discussed above. The present invention generally relates to a process and method for the management of fitness, health and/or wellness specialist services. More particularly, the present invention relates to a process and method for the management of health and/or wellness specialist services utilizing a pay by the minute procedure and the tracking of a user's time. In the following discussion, the general practice of the invention will be discussed with particular reference to managing health and/or wellness specialist services for a user of a health center. However, it is to be understood that these uses of the invention are simply exemplary uses and should not be considered as limiting.

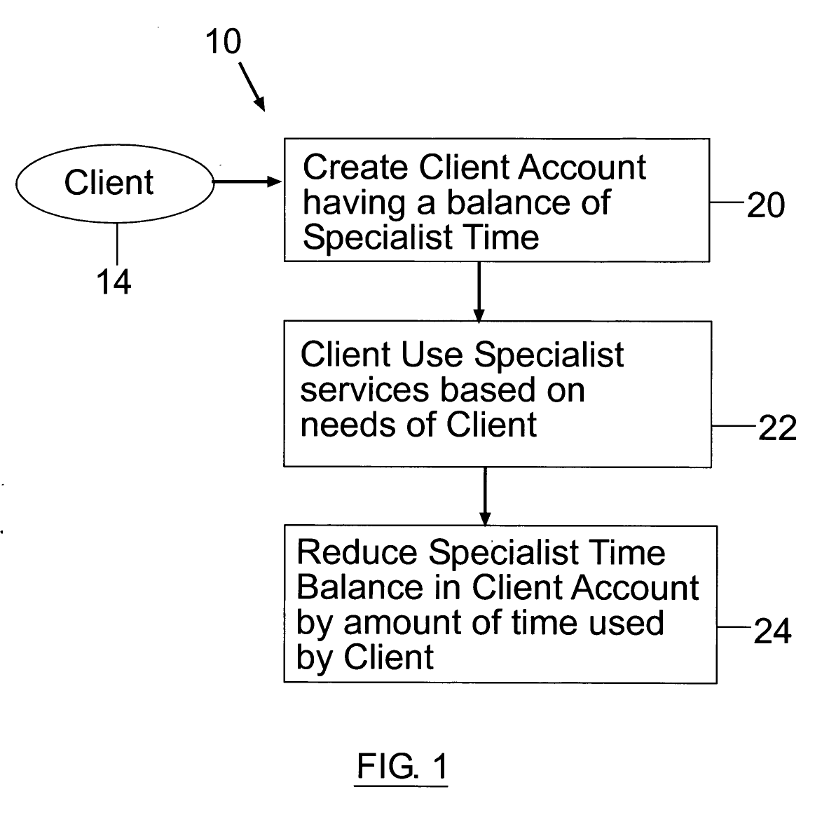

An exemplary fitness, health and/or wellness management method 10 incorporating features of the invention is schematically shown in FIG. 1. In the general practice of the invention, a fitness, health and/or wellness specialist provides fitness, health and/or wellness services to a client, usually in the context of a health center or similar setting. As used herein, the term “health center” is defined as a health club, therapeutic center, corporate fitness center, hospital, physical therapy clinic, occupational health clinic, sports center, sports club, or any other facility that provides health and/or wellness services. Prior to utilizing the specialists services, the client creates a use account having a balance of specialist minutes. As will be discussed in greater detail below, the account can be stored on a computer readable medium. When the client utilizes the specialist's services, the amount of time associated therewith is reduced from the client's balance of specialist minutes. This allows a client to have access to a health and/or wellness specialist's expertise for a specific amount of time based on the individual's particular needs. The individual is not required to pay for unnecessary specialist time.

In the general practice of the invention as described in FIG. 1, a method 10 is illustrated and comprises a client 14 who desires a particular fitness, health and/or wellness service, the client 14 creates a client account (step 20), and in so doing establishes a balance of specialist minutes. This is accomplished purchasing a block of minutes. The client then is able to use the services provided by the specialist (step 22). The client's balance of minutes is then reduced by the time associated with that session (step 24). This allows for a client to use the health and/or wellness specialist services based on the client's time needs.

By allowing the client to dictate the amount of time spent on a specialist's services, that individual maintains control over her special health program. Additionally, this reduces any tension or discontent the client may feel toward the specialist. In the prior art, tension could develop between the client and specialist due to the client being required to pay for an appointment of a pre-determined length of time irrespective of the client's needs. This method eliminates the practice of paying for services and/or time which is not needed.

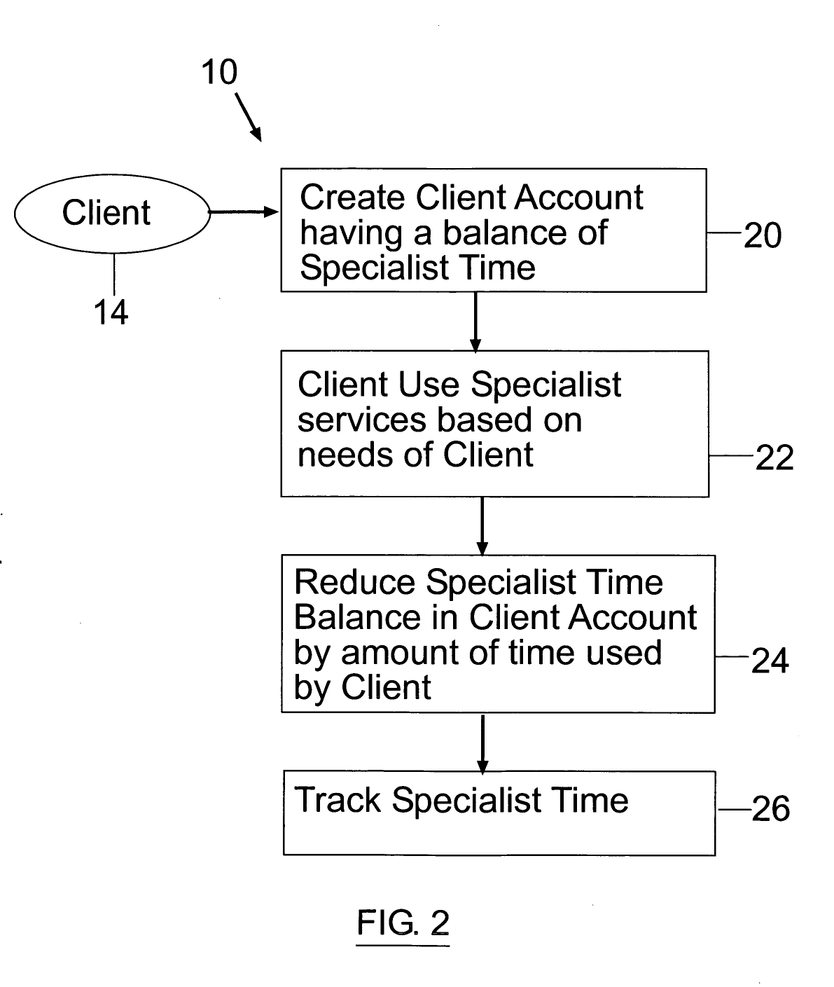

A further example of the invention, with references to FIG. 2, the method is as set out above with the addition of the tracking of the time with respect to one or more specialists in conjunction with one or more clients (step 26). This allows for the monitoring of a client's use of one or more specialists, along with the monitoring of a specialist in conjunction with one or more clients.

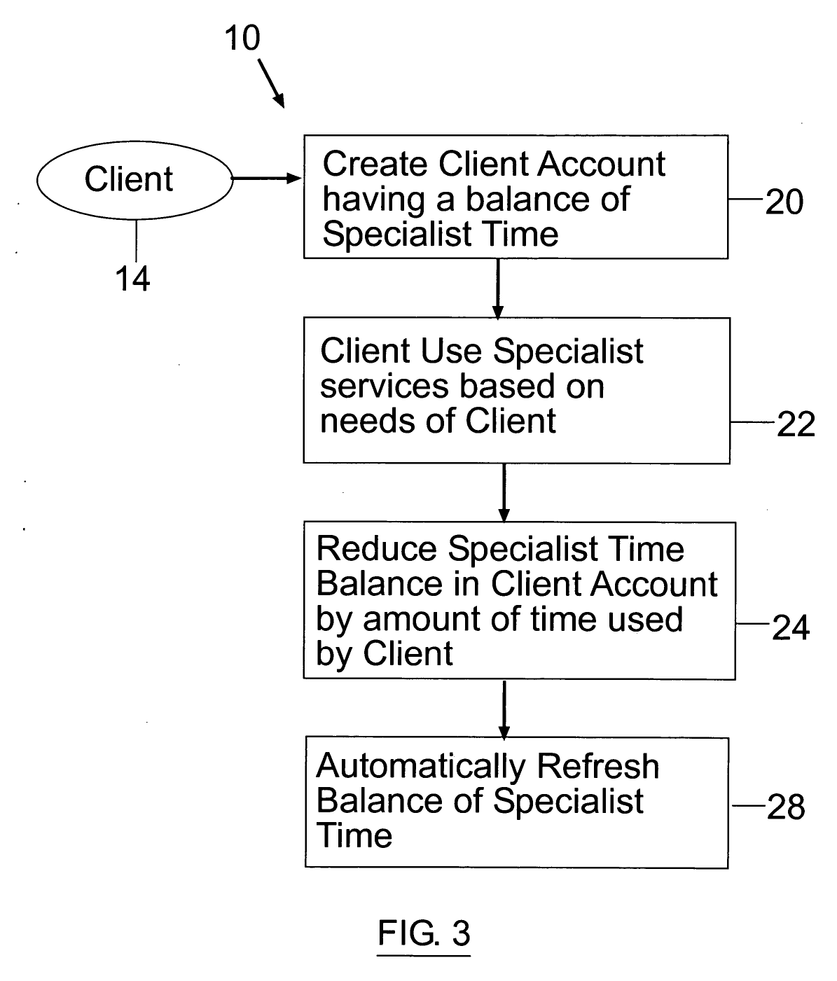

A further example of the invention, with references to FIG. 3, comprises a method as set out above with the addition of the automatic refreshing of a client's balance of minutes in the event the balance drops below a minimum amount of minutes (step 28). The allows for the ease of establishing the client account.

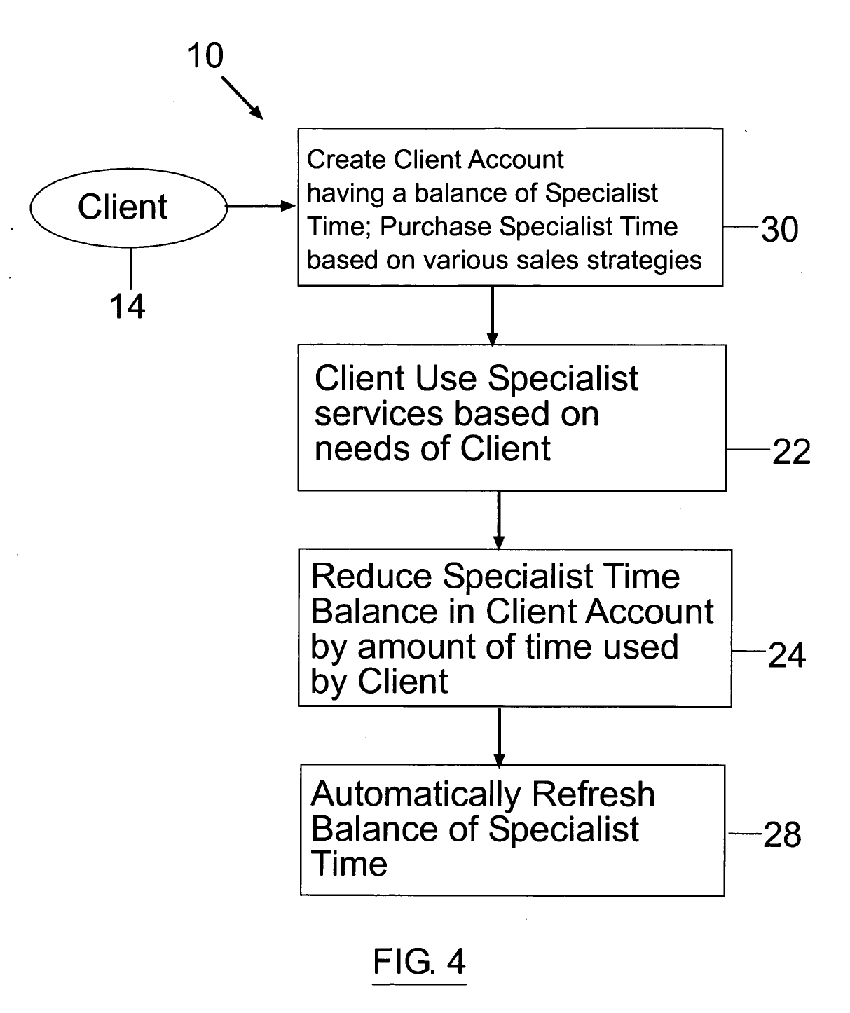

Another example of the invention, with references to FIG. 4, comprises a method as set out above wherein the ability to create an account balance is performed by purchasing time for specialists, i.e. specialist's time, in various manners (step 30). One variation is the point of sale purchase, i.e. purchase 15 minutes to participate in a specialist lead group exercise. Another variation is the period purchase, including short term and long term purchases. During both the short term and long term purchase an individual agrees to buy, over a series of time periods, a specific amount of time per period, where the short term agreement is for a few time periods and the long term agreement is for a many time periods. Moreover, this time is to be used during the month in which they were purchased. As an example, the purchase of 60 minutes of time per month for three months could be considered a short term agreement whereas an agreement that extends for 12 mouths could be considered a long term agreement. This example is illustrative and is not meant to be a limit on the scope of the present invention. Another variation is the paid in full arrangement. This arrangement allows an individual to purchase a block of time, such as 1000 specialist minutes, which can be used at any time by the individual.

Additional variations of this aspect include adjusting the per unit cost of fitness health and/or wellness specialist minutes based on the volume of minutes purchased such that the more minutes purchased, the lower the cost is per unit. An example of this includes purchasing 100 specialist minutes at $2.00 per minute as compared to purchasing 500 specialist minutes at $1.00 per minute.

Another example of the present invention comprises a system for the management of fitness, health and/or wellness specialist services based on a client's needs, through the payment of fitness, health and/or wellness specialist services on a per minute basis where the management of the system controlled by a computer system having various hardware and software components. The computer system can be local to the fitness, health and/or wellness specialist or can be a computer network having various computer hardware components such as at least one data server and one or more client computers; along with a compatible computer software component.

While the invention has been described with a certain degree of particularity, it is understood that the invention is not limited to the embodiments set forth herein for purposes of exemplification, but is to be limited only by the scope of the attached claims or including the full range of equivalency to which each element thereof is entitled.

We claim:

1. A method for management of fitness, health and/or wellness specialist services comprising:
creating a user account having a balance of specialist minutes;
using fitness, health and/or wellness services provided by a fitness, health and/or wellness specialist for a period of minutes based on the needs and/or wants of the user; and
reducing the balance of specialist minutes by the period of minutes to create a modified balance of specialist minutes.

2. The method of claim 1, wherein the user account created in the step of creating a user account is further defined as purchasing a block of specialist minutes on a per unit cost to create the balance of specialist minutes.

3. The method of claim 1, further comprising the step of tracking the specialist minutes used by the user.

4. The method of claim 1, further comprising the step of automatically refreshing a balance of specialist minutes when the balance of specialist minutes drops below a minimum level of minutes.

5. The computerized method of claim 1, wherein the fitness, health and/or wellness specialist is selected from the group consisting of personal trainers, exercise specialists, nutritionists, massage therapists, and any other individual trained, irrespective of certification or registration, who assists individuals obtaining and/or maintaining a healthy lifestyle.

6. A computerized method for management of fitness, health and/or wellness specialist services, comprising the steps of:
creating a user account having a balance of specialist minutes;
storing the user account on a computer readable medium;
using health and/or wellness services provided by a fitness, health and/or wellness specialist for a period of minutes;
reducing the balance of specialist minutes by the period of minutes to create a modified balance of specialist minutes;
storing the modified balance of specialist minutes on the computer readable medium.

7. The computerized method of claim 6, wherein the user account created in the step of creating a user account is further defined as purchasing a block of specialist minutes on a per unit cost to create the balance of specialist minutes.

8. The computerized method of claim 6, further comprising the step of tracking the specialist minutes used by one or more users.

9. The computerized method of claim 6, further comprising the step of automatically refreshing a balance of specialist minutes when the balance of specialist minutes drops below a minimum level of minutes.

10. The computerized method of claim 6, wherein the computer readable medium is defined as a computer network having at least one data server, at least client computer and compatible computer software.

11. The computerized method of claim 6, wherein the fitness, health and/or wellness specialist is selected from the group consisting of personal trainers, exercise specialists, nutritionists, massage therapists, and any other individual trained, irrespective of certification or registration, who assists individuals obtaining and/or maintaining a healthy lifestyle.
